(19) United States
(12) Patent Application Publication
(10) Pub. No.: US 2011/0089228 A1
(43) Pub. Date: Apr. 21, 2011

(54) CONTINUOUS WORKING DEVICE

(75) Inventor: Shuichi Goto, Tokyo (JP)

(73) Assignee: IDEMITSU UNITECH CO., LTD, Tokyo (JP)

(21) Appl. No.: 12/997,261

(22) PCT Filed: Jun. 8, 2009
(86) PCT No.: PCT/JP2009/060448

§ 371 Date: Dec. 10, 2010

(30) Foreign Application Priority Data
Jun. 11, 2008 (JP) 2008-152800
Jul. 3, 2008 (JP) 2008-174447

(51) Int. Cl. B26F 1/04

(52) U.S. Cl. 234/128

(57) ABSTRACT

A continuous machining device includes: a film machining mechanism that forms a hole in a film; a holding mechanisms being provided integrally with the film machining mechanism; a slider that supports the film machining mechanism and the holding mechanism in a reciprocative manner relative to a feeding direction of the film; and a return mechanism that returns the film machining mechanism and the holding mechanism to their respective original positions defined on the opposite sides to the feeding direction of the film. When the film is held by the holding mechanism, the film machining mechanism can be moved in synchronization with the film. Thus, after the hole is formed in the film by the film machining mechanism, the film machining mechanism and the holding mechanism can be returned to their respective original positions by the return mechanism as soon as the film is released from the holding mechanism.

### TECHNICAL FIELD

The present invention relates to a continuous machining device capable of continuously machining a film that is continuously fed in a single direction, for instance, capable of continuously forming holes or sealed portions in the film at predetermined intervals.

### BACKGROUND ART

A various kinds of containers have been used to package food products, detergents or the like. An example of such containers is a packaging bag produced by cutting a film after predetermined positions on the film are sealed. Such a packaging bag includes a standing pouch having a bottom that is widened so that the standing pouch can stand on a rack to be displayed.

In order to keep the standing pouch in a standing posture, the bottom of the standing pouch is in a unique shape. For this reason, holes are formed in the process of machining the film.

The standing pouch is produced by using a continuous machining device in which holes or sealed portions are continuously formed in a film, which is pulled from a raw-film roll by a feeding roller and a pulling roller, at predetermined intervals along the feeding direction (running direction) of the film.

The continuous machining device uses a punching mechanism for forming the holes or a sealing mechanism for forming the sealed portions. While the punching mechanism or the sealing mechanism is in operation, the punching mechanism or the sealing mechanism and the film needs to be relatively stationary. In a conventional machining device, rollers are intermittently rotated so that holes or sealed portions are formed when a film is stationary. However, since the film needs to be temporarily stationary when the punching mechanism or the sealing mechanism is in operation, it takes time to machine the film.

In view of the above, there has been provided a box-motion type continuous machining device in which a film machining mechanism such as a punching mechanism is moved in the feeding direction of a film by a predetermined distance so that the film is subjected to a predetermined machining without stopping the rotation of the rollers, thereby shortening the time requested for machining the film.

A conventional example of such a box-motion type device is a device capable of continuously sealing a film fed in a single direction, in which a frame provided with a heating bar is disposed in a reciprocative manner along the feeding direction of the film and a lever for swinging the frame is connected to a motor (Patent Literature 1). In Patent Literature 1, the motor is controlled so that the frame is moved at the same speed as the feeding speed of the film via the lever.

### CITATION LIST

### Patent Literature

Patent Literature 1: JP-A-7-291234

### SUMMARY OF THE INVENTION

### Problems to be Solved by the Invention

In the conventional example of Patent Literature 1, in order to seal predetermined positions on the film, it is required to synchronize the feeding of the film with the frame provided with the heating bar. In view of the above, the rotation speed of a supply roller or the like is controlled so that the feeding speed of the film becomes constant and the movement speed of the frame provided with the heating bar is controlled to be synchronized with the constant feeding speed of the film.

Thus, the conventional example of Patent Literature 1 requires a highly-accurate motor for moving the frame, which increases the cost of the continuous machining device. Moreover, the conventional example of Patent Literature 1 requires a complicated control using a servo motor or the like, which results in deterioration of operability at the time of the operation, repair or the like of the device.

An object of the present invention is to provide a continuous machining device that does not require a costly driving mechanism such as a motor, so that the production cost of the device is low and the operability of the device is excellent.

### Means for Solving the Problems

According to an aspect of the present invention, a continuous machining device capable of continuously machining a film continuously fed in a single direction, includes: a film machining mechanism that machines the film; a holding mechanism that alternately performs a process for holding the film and a process for releasing the film; a support mechanism that supports the film machining mechanism and the holding mechanism in a reciprocative manner relative to a feeding direction of the film; and a return mechanism that returns the film machining mechanism and the holding mechanism to respective original positions thereof.

With the above arrangement, the holding mechanism holds the film continuously fed in the single direction. As a result, the holding mechanism and the film machining mechanism are moved in synchronization with the film with the assistance of the support mechanism, so that the film machining mechanism becomes stationary relative to the film. While being moved in synchronization with the film, the film machining mechanism is operated to perform a predetermining machining on the film.

After the predetermined machining on the film, the holding mechanism is separated from the film. As a result, while the film is still continuously fed independently of the holding mechanism and the film machining mechanism, the holding mechanism and the film machining mechanism are returned to their respective original positions by the return mechanism. Subsequently, the film continuously fed in the single direction is again held by the holding mechanism so that the above film machining is performed. A box motion consisting of the above processes is repeated to continuously perform the predetermined machining on the film.

Thus, since no costly servo motor or the like is required to drive the film machining mechanism for the box motion, the production cost of the continuous machining device can be reduced. Furthermore, since the device does not require a complicated control by using a servo motor or the like, the device can be easily operated and repaired.

According to another aspect of the present invention, a continuous machining device capable of continuously machining a film continuously fed in a single direction, includes: a film machining mechanism that machines the film; a belt mechanism that includes a plurality of rollers each being longer than a widthwise dimension of the film and a belt wound on the rollers to be synchronized with the film; a holding mechanism that alternately performs a process for holding the belt and a process for releasing the belt; a support mechanism that supports the film machining mechanism and the holding mechanism in a reciprocative manner relative to a feeding direction of the film; and a return mechanism that returns the film machining mechanism and the holding mechanism to respective original positions thereof.

With the above arrangement, the belt of the belt mechanism is moved in synchronization with the film and the synchronously-moved belt is held by the holding mechanism. As a result, the holding mechanism and the film machining mechanism are moved in the feeding direction of the film in synchronization with the film and the belt with the assistance of the support mechanism, so that the film machining mechanism becomes stationary relative to the film. While the film machining mechanism is moved in synchronization with the film and the belt, the film machining mechanism is operated to perform a predetermined machining on the film.

After the predetermined machining on the film, the holding mechanism is separated from the film. As a result, while the film and the belt are still continuously fed independently of the holding mechanism and the film machining mechanism, the holding mechanism and the film machining mechanism are returned to their respective original positions by the return mechanism. Subsequently, the belt moved in the single direction along with the film is again held by the holding mechanism so that the above film machining is performed. A box motion consisting of the above processes is repeated to continuously perform the predetermined machining on the film.

With the above arrangement, as described above, since no costly servo motor or the like is required to drive the film machining mechanism, the production cost of the continuous machining device can be reduced. Furthermore, since the device does not require a complicated control by using a servo motor or the like, the device can be easily operated and repaired.

Furthermore, with the above arrangement, it is not required to directly hold the film in order to allow the holding mechanism and the film machining mechanism to synchronously follow the film. Thus, even when the film machining mechanism is provided by a device with a large weight such as a heat-sealing device or a cooling device or even when a film with a low strength is used, it is possible to perform the predetermined machining without damaging the film.

In either one of the above aspects, it is preferable that the continuous machining device include a sensor that detects a predetermined position on the film, in which an operation of the holding mechanism is controlled by a signal from the sensor. With the above arrangement, a timing at which the holding mechanism holds the film or the belt is determined based on predetermined positions shown by print marks or the like. Thus, the film does not need to be subjected to any special process. Also as a result of the above, the cost of the continuous machining device can be reduced.

It is preferable that the holding mechanism include: a pair of rods opposed to each other with an object to be held being interposed therebetween; and a rod advancing-and-retracting mechanism that advances and retracts at least one of the rods.

With the above arrangement, the film or the belt as the object to be held is interposed between the pair of rods and at least one of the rods is advanced and retracted by the rod advancing-and-retracting mechanism. Thus, the process for holding and the process for releasing can be easily switched.

It is preferable that the support mechanism include a slider on which the film machining mechanism and the holding mechanism are mounted.

With the above arrangement, since the slider enables the film machining mechanism and the holding mechanism to constantly move together, the structure of the support mechanism can be simplified.

It is preferable that the return mechanism include a cylinder mechanism that constantly biases the film machining mechanism and the holding mechanism in an opposite direction to the feeding direction of the film.

With the above arrangement, since the return mechanism includes the cylinder mechanism, the structure of the return mechanism can be simplified. Furthermore, irrespective of the positions of the film machining mechanism and the holding mechanism relative to the return mechanism, a constant biasing force can be applied to the film machining mechanism and the holding mechanism by the cylinder mechanism. Thus, force applied to the film or the belt held by the holding mechanism can become constant, thereby preventing a problem such as elongation of the film or the belt.

It is preferable that the film machining mechanism be provided by a punching mechanism that forms a hole in the film.

With the above arrangement, a low-cost device can be used to form a hole in the film.

### BRIEF DESCRIPTION OF DRAWINGS

FIG. 1 is a front view showing the schematic structure of a continuous machining device according to a first exemplary embodiment of the present invention.

FIG. 2 is a plan view of the continuous machining device.

FIG. 3 is a perspective view showing a primary part of a film machining mechanism.

FIG. 4A shows the operation of the continuous machining device.

FIG. 4B shows the operation of the continuous machining device.

FIG. 5A shows the operation of the continuous machining device.

FIG. 5B shows the operation of the continuous machining device.

FIG. 6, corresponding to FIG. 1, shows a continuous machining device according to a second exemplary embodiment of the present invention.

FIG. 7, corresponding to FIG. 2, shows the continuous machining device according to the second exemplary embodiment of the present invention.

### DESCRIPTION OF EMBODIMENTS

A first exemplary embodiment of the present invention will be described below with reference to the attached drawings.

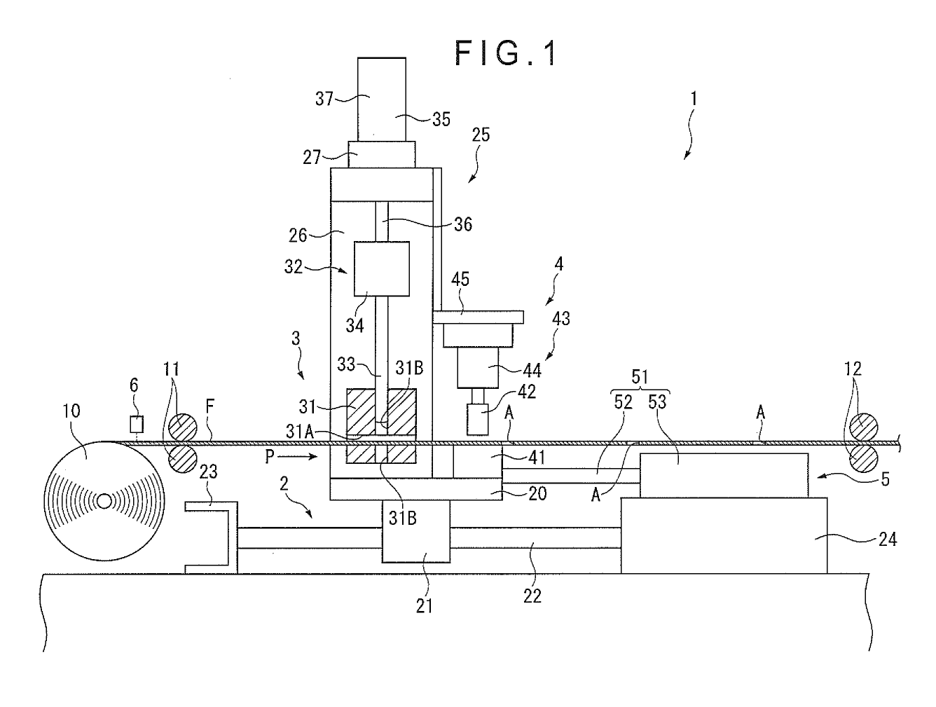

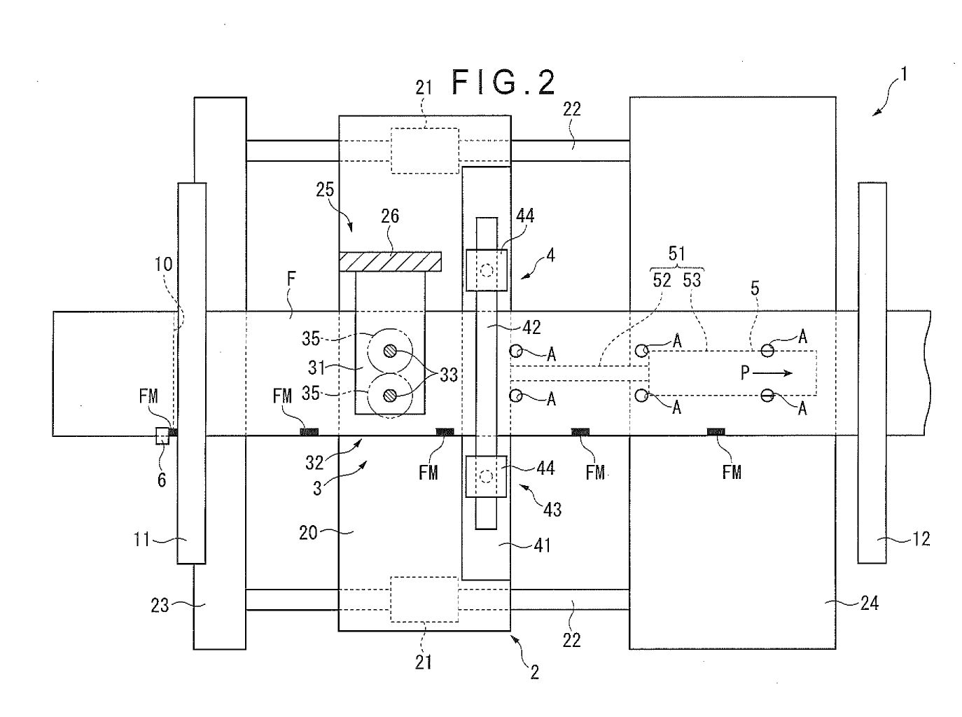

FIGS. 1 and 2 are respectively a front view and a plan view showing the schematic structure of a continuous machining device according to the first exemplary embodiment.

As shown in FIGS. 1 and 2, a continuous machining device 1 is used in the process of producing a standing pouch as an example of a packaging bag to continuously form holes in a film F continuously fed in a single direction. In the continuous machining device 1, a raw-film roll 10 is disposed on the upstream side in a film-feeding direction P and a storage box (not shown) is disposed on the downstream side in the film-feeding direction P. In the storage box, standing pouches that have passed through a machining device such as a film-cutting device (not shown) are piled and stored. The film F taken from the raw-film roll 10 is continuously fed in the single direction by using a feeding roller 11 and a pulling roller 12. The feeding roller 11 is disposed on the upstream side in the film-feeding direction P relative to the continuous machining device 1 and the pulling roller 12 is disposed on the downstream side in the film-feeding direction P relative to the continuous machining device 1. Each of the feeding roller 11 and the pulling roller 12 includes a pair of shaft members that are opposed to each other with the film F interposed therebetween. These shaft members are formed to be longer than the widthwise dimension of the film F.

The film F is formed of a film generally used to make a standing pouch, such as a multilayered film in which a base layer and a seal layer are laminated, or a multilayered film in which a base layer, an aluminum layer and a seal layer are laminated. Print marks FM (phototube marks) are beforehand printed at predetermined positions on the film F (for instance, edges of the film F).

The continuous machining device 1 includes a slider 2 as a support mechanism, a film machining mechanism 3 and a holding mechanism 4 each being integral with the slider 2, and a return mechanism 5 that returns the slider 2 to a predetermined position. The slider 2 includes a base body 20 in a rectangular plate shape in a plan view. On the lower side of the base body 20, two slide units 21 are fixed side by side in a direction perpendicular to the film-feeding direction P. A guiding rod 22 is assigned to each of the slide units 21 to allow a slide movement with less friction. The guide rods 22 extend in the film-feeding direction P.

The first ends of the guide rods 22 are fixed to a fixing block 23 disposed on the upstream side in the film-feeding direction P and the second ends of the guide rods 22 are fixed to a fixing block 24 disposed on the downstream side in the film-feeding direction P. The fixing block 23 has a U-shaped side surface and the fixing block 24 is formed in a box shape.

A column 25 is fixed to the base body 20. The column 25 includes a plate-shaped member 26 that vertically extends and an engaging piece member 27 provided to the upper end of the plate-shaped member 26.

The film machining mechanism 3 is provided by a punching mechanism that forms in the film F holes A spaced at a predetermined interval. The film machining mechanism 3 includes a block 31 fixed to the plate-shaped member 26 and a punch driving mechanism 32 fixed to the engaging piece member 27.

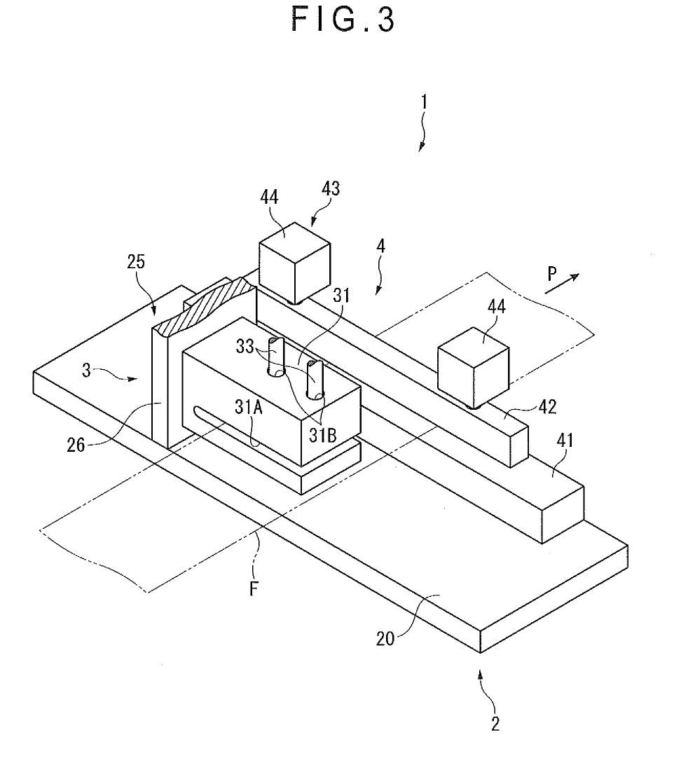

FIG. 3 shows a primary part of the film machining mechanism 3. As shown in FIG. 3, the block 31 is shaped in a substantially rectangular parallelepiped and is fixed to the column 25 such that the position of the lower surface of the block 31 is set at a predetermined level above the upper surface of the base body 20. The block 31 is provided with a slit 31A that extends in the horizontal direction from one edge of the film F to a predetermined lengthwise position. As shown in FIGS. 1 to 3, the block 31 is provided with two through holes 31B that are shaped in a circle in a plan view and extend in the up-and-down direction. The through holes 31B are communicated with the slit 31A at the middle thereof. The slit 31A guides the film F to the through holes 31B while keeping the attitude of the film F in a horizontal plane. Incidentally, though the width of the slit 31A is exaggerated in order to clearly illustrate the structure of the silt 31A, the actual width is only slightly larger than the thickness of the film F.

The punch driving mechanism 32 includes two punching rods 33 respectively inserted into the through holes 31B of the block 31, and air cylinders 35 respectively connected and fixed to the punching rods 33 via a joint 34 while being fixed to the engaging piece member 27.

Each of the punching rods 33 has a blade provide to the end thereof to form the circular holes A in the film F inserted in the silt 31A. Incidentally, each of the through holes 31B is divided into an upper portion and a lower portion by the slit 31A disposed therebetween. The lower portion of the through hole 31B has a dimension substantially equal to or slightly larger than the outer dimension of the punching rod 33 so as to reliably form the holes A in the film F. The upper portion of the through hole 31B has a dimension larger than the outer dimension of the lower portion of the through hole 31B so as to smoothly guide the punching rod 33.

Each of the air cylinders 35 includes a piston 36 connected to the joint 34, and a case 37 that accommodates the piston 36 therein and is attached to the upper surface of the engaging piece member 27.

The holding mechanism 4 alternately performs a process for holding the film F (an object to be held) and a process for releasing the film F. The holding mechanism 4 includes a pair of holding rods 41 and 42 vertically opposed to each other with the film F interposed therebetween, and a rod advancing-and-retracting mechanism 43 that advances and retracts the holding rod 42 on the upper side.

The holding rod 41 on the lower side is fixed on the upper surface of the base body 20 on the downstream side in the film-feeding direction P relative to the block 31. The holding rod 41 is provided by a square bar member with a rectangular cross section. The longitudinal direction of the holding rod 41 is set perpendicular to the film-feeding direction P and the length of the holding rod 41 is longer than the width of the film F.

The holding rod 42 on the upper side is provided by a square bar member with a rectangular cross section as in the holding rod 41. The longitudinal direction of the holding rod 42 is also set perpendicular to the film-feeding direction P as in the holding rod 41. The length of the holding rod 42 is longer than the width of the film F but shorter than the length of the holding rod 41. The film F is held between the opposed flat surfaces of the holding rods 41 and 42.

The rod advancing-and-retracting mechanism 43 includes two air cylinders 44 that are connected to the holding rod 42 on the upper side. The upper ends of the air cylinders 44 are attached to the column 25 via an L-shaped bracket 45. The air cylinders 44 are respectively disposed at positions corresponding to both of the edges of the film F.

The return mechanism 5 returns the film machining mechanism 3 and the holding mechanism 4 back to their respective original positions defined on the upstream side in the film-feeding direction P and includes a cylinder mechanism 51 connected to the distal end of the slider 2 in the film-feeding direction.

The cylinder mechanism 51 includes a piston 52 being in contact with the substantial center of the distal end surface of the base body 20 in the film-feeding direction P, and a cylinder 53 that constantly biases the piston 52 in the direction opposite to the film-feeding direction P. The cylinder 53 is fixed to the upper surface of the fixing block 24.

A sensor 6 that detects the print marks FM beforehand printed on the film F is disposed on the upstream side in the film-feeding direction P relative to the film machining mechanism 3 and the holding mechanism 4.

The sensor 6, the film machining mechanism 3 and the holding mechanism 4 are connected to a controller (not shown). Upon receipt of a detection signal from the sensor 6 or after elapse of a predetermined time from receipt of a detection signal, the controller sends a signal to the holding mechanism 4 to perform the process for holding the film F. Subsequently, after elapse of a predetermined time, the controller sends a signal to the film machining mechanism 3 so that the punching rods 33 are advanced by the punch driving mechanism 32. Subsequently, after elapse of a predetermined time, the controller sends a signal to the holding mechanism 4 to perform the process for releasing the film F. Incidentally, in the first exemplary embodiment, the arrangement of the sensor 6 is not specifically defined as long as the sensor 6 is capable of detecting the print marks FM. Accordingly, for instance, the sensor 6 may emit light to the edge of the film F to receive the reflected light, thereby detecting presence or absence of the print marks FM.

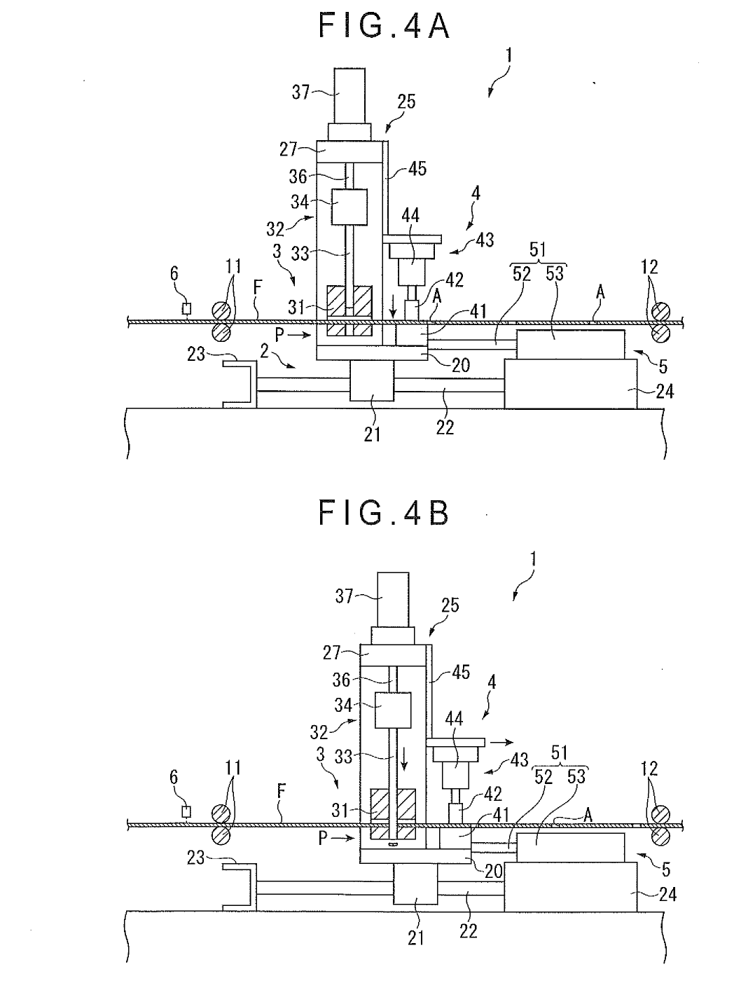

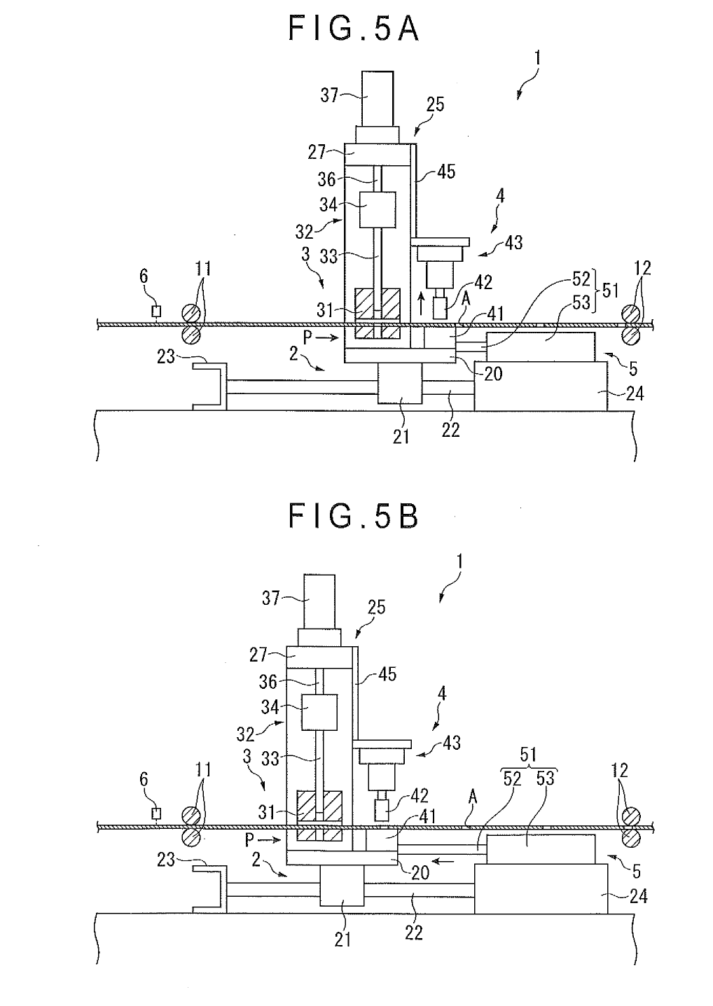

Next, description will be made on the operation of the continuous machining device according to the first exemplary embodiment with reference to FIGS. 4A, 4B, 5A and 5B.

Initially, as shown in FIG. 4A, upon detection of one of the print marks FM on the film F fed at a predetermined speed, the sensor 6 sends a detection signal to the holding mechanism 4 via the controller, so that the holding mechanism 4 performs the process for holding the film F.

Specifically, the air cylinders 44 are advanced, so that the film F is held between the upper-side holding rod 42 connected to the ends of the air cylinders 44 and the lower-side holding rod 41. Since the film F is constantly fed at the predetermined speed, the holding mechanism 4, the film machining mechanism 3 and the slider 2 are moved together with the film F. During this movement, weak reaction force is applied to the slider 2 from the return mechanism 5.

Then, as shown in FIG. 4B, after elapse of the predetermined time, a signal is sent from the controller to the film machining mechanism 3, so that the punching rods 33 of the punch driving mechanism 32 are advanced. The punching rods 33 are moved along the axial direction of the through holes 31B of the block 31 to punch the holes A in the film F inserted in the slit 31A. Pieces punched out of the film are pushed into a space between the block 31 and the base body 20 by the punching rods 33. Since the two punching rods 33 are arranged in the width direction of the film F to form the two holes A spaced at the predetermined interval in the width direction of the film F, the bottom of the standing pouch can be formed in a unique shape in a sealing process (following process).

Subsequently, as shown in FIG. 5A, after elapse of the predetermined time, a signal is sent from the controller to the holding mechanism 4 to release the film F, so that the holding mechanism 4 performs the process for releasing the film F. Specifically, the air cylinders 44 are retracted, so that the upper-side holding rod 42 connected to the ends of the air cylinders 44 are separated from the lower-side holding rod 41, thereby releasing the film F from the holding mechanism 4.

As a result, as shown in FIG. 5B, while the film F is constantly fed at the predetermined speed, the holding mechanism 4, the film machining mechanism 3 and the slider 2 are returned in the opposite direction to the film-feeding direction P by the return mechanism 5. In other words, since the piston 52 is biased in the opposite direction to the film-feeding direction P by the cylinder 53, the holding mechanism 4 and the film machining mechanism 3 are returned to their respective original positions by the cylinder 53 as soon as the film F is released from the holding mechanism 4. When the sensor 6 again detects another one of the print marks FM on the film F, the holding mechanism 4 holds the film F in response to the detection signal from the sensor 6 so that the holes A are punched in the film F. After the formation of the holes A, the holding mechanism 4 releases the film F and the holding mechanism 4 and the film machining mechanism 3 are returned to their respective original positions. The box motion consisting of the above processes is repeated, so that the holes A are continuously formed in the film F.

According to this embodiment, the following advantages can be obtained.

(1) The continuous machining device 1 includes the film machining mechanism 3 that forms the holes A in the film F, the holding mechanism 4 that holds and releases the film F (an object to be held), the slider 2 that supports the film machining mechanism 3 and the holding mechanism 4 in a reciprocative manner along the film-feeding direction P of the film F, and the return mechanism 5 that returns the slider 2 to the original position thereof. With the above arrangement, when the holding mechanism 4 holds the film F, the film machining mechanism 3 is moved in synchronization with the film F. Furthermore, after the holes A are formed in the film F by the film machining mechanism 3, the film machining mechanism 3 and the holding mechanism 4 can be returned to their respective original positions by the return mechanism 5 as soon as the film F is released from the holding mechanism 4.

Thus, since no costly servo motor or the like is required to drive the film machining mechanism 3 for the box motion, the production cost of the device can be reduced. Furthermore, since the device does not require complicated control by using a servo motor or the like, the device can be easily operated and repaired.

(2) The holding mechanism 4 includes the pair of holding rods 41 and 42 that are opposed to each other with the film F (an object to be held) interposed therebetween, and the rod advancing-and-retracting mechanism 43 that advances and retracts the holding rod 42 on the upper side. With the above arrangement, the object can be easily and reliably held by and released from the holding mechanism 4.
(3) The holding rods 41 and 42 are shaped like square pillars so that the object is held between the surfaces of the holding rods 41 and 42 corresponding to the side surfaces of the square pillars.

With the above arrangement, since the object can be held between large rectangular planes defined in the longitudinal direction of the holding rods 41 and 42 and in the direction perpendicular to the longitudinal direction of the holding rods 41 and 42, pressing force is not concentrated in a particular portion on the object, thereby preventing damages on the object.

(4) Since the dimensions of the holding rods 41 and 42 are set longer than the widthwise dimension of the film F, the holding rods 41 and 42 exhibit the same pressing force in the width direction of the film F, thereby preventing the film F from being damaged or elongated.
(5) The rod advancing-and-retracting mechanism 43 includes the air cylinders 44 connected to the holding rod 42 on the upper side. Thus, the holding rod 42 can be moved upward and downward with a simple structure. Furthermore, by instantly supplying air to the air cylinders 44, the holding rod 42 can be instantly advanced. Thus, the holding rod 42 is rapidly moved downward to hold the object against the holding rod 41 in a short time, thereby shortening the time for machining the film.
(6) Since the film machining mechanism 3 includes the block 31 provided with the slit 31A that extends in the horizontal direction so that the film F is inserted therein, the film F can be guided and positioned by the slit 31A. Thus, the holes A can be accurately formed at the predetermined positions on the film F.
(7) The film machining mechanism 3 includes the punching rods 33 inserted into the through holes 31B of the block 3 divided into the upper and lower portions, and the air cylinders 35 connected to the punching rods 33. Thus, by advancing and the retracting the air cylinders 35, the continuous holes A can be easily formed in the film F.
(8) Since the block 31 is fixed to the column 25 while the lower surface of the block 31 is set at the predetermined level above the upper surface of the base body 20, the pieces punched out of the film by the punching rods 33 are prevented from accumulating in the through holes 31B. Thus, the device can be easily maintained.
(9) The through holes 31B are divided at the middle thereof into the upper and lower portions by the slit 31A in which the film F is inserted and the upper portions of the through holes 31B function as guiding portions for the punching rods 33. Thus, the film F is smoothly punched by the punching rods 33.
(10) With the sensor 6, the film F can be held by the holding mechanism 4 at the timing determined based on the print marks FM. Thus, the film does not need to be subjected to any special process. Also as a result of above, the cost of the continuous machining device 1 can be reduced.
(11) The film machining mechanism 3 and the holding mechanism 4 are mounted on the slider 2. Specifically, since the film machining mechanism 3 and the holding mechanism 4 are attached to the base body 20 of the slider 2 and the slider body 20 is reciprocatively supported on the guide rods 22, the structure of the support mechanism can be simplified.
(12) The return mechanism 5 includes the piston 52 being in contact with the slider 2, and the cylinder 53 that constantly biases the piston 52 in the direction opposite to the film-feeding direction P of the film F. Thus, the structure of the return mechanism 5 can be simplified. Since the constant biasing force can be applied to the slider 2 irrespective of the position of the slider 2 relative to the return mechanism 5, the force applied to the film F held by the holding mechanism 4 can be made constant, thereby preventing trouble such as elongation of the film F.

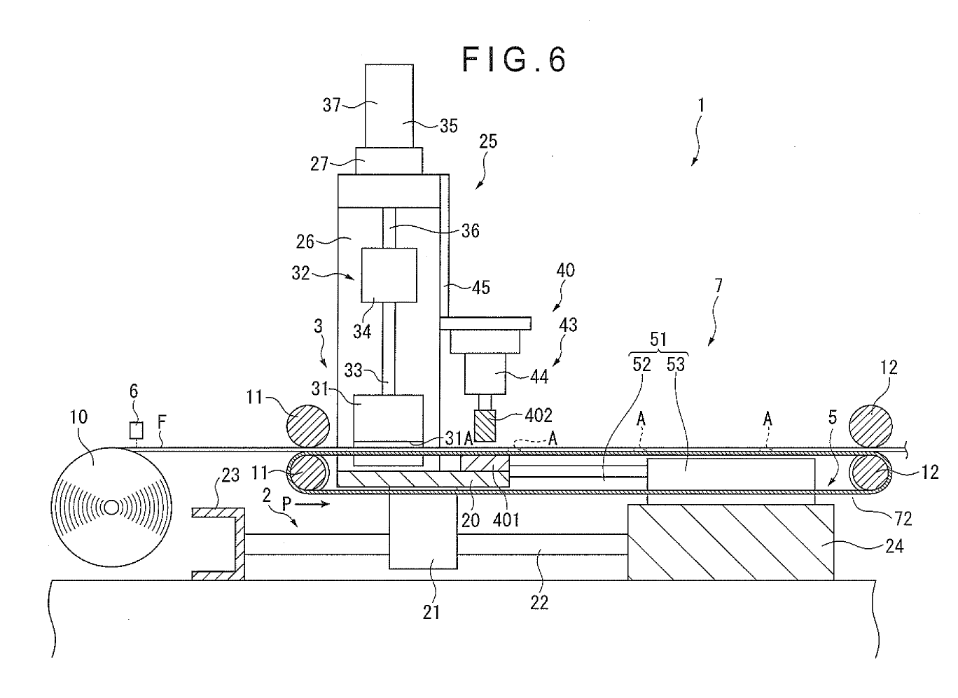

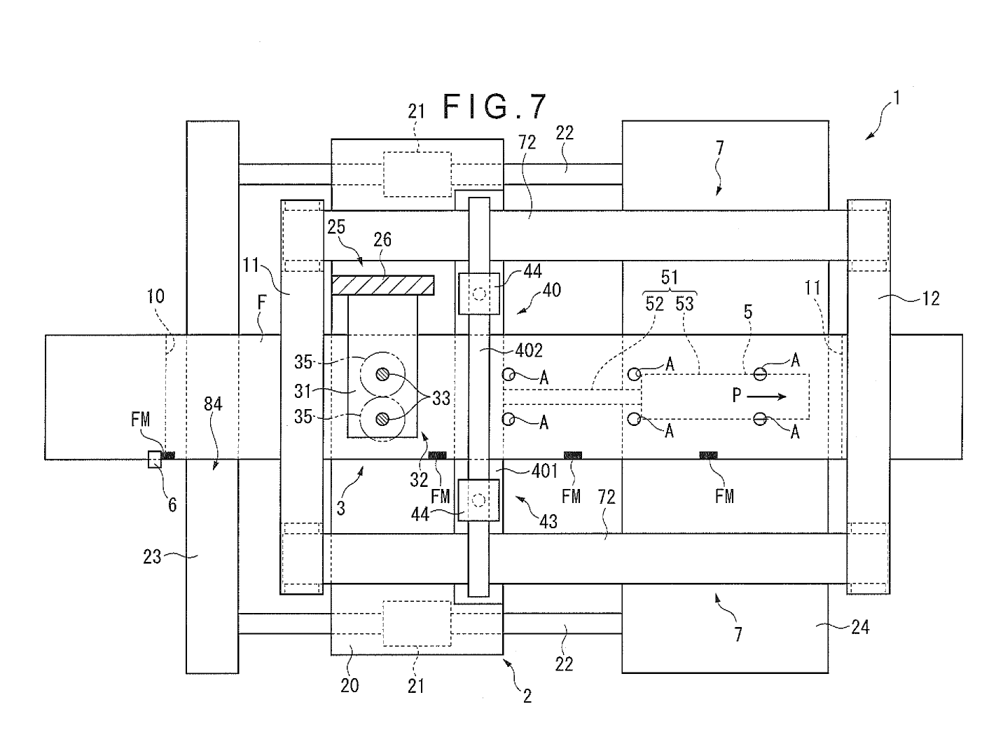

Next, a second embodiment of the present invention will be described with reference to FIGS. 6 and 7. The second exemplary embodiment differs from the first exemplary embodiment in the arrangement of a holding mechanism, but the other arrangements are the same as those according to the first exemplary embodiment. In the following description on the second exemplary embodiment, like reference numerals are attached to elements identical to those in the first exemplary embodiment and the description thereof is omitted.

FIG. 6, corresponding to FIG. 1, shows a continuous machining device according to the second exemplary embodiment. FIG. 7, corresponding to FIG. 2, shows the continuous machining device according to the second exemplary embodiment. In FIGS. 6 and 7, a continuous machining device 1 includes: an upper and lower pair of feeding rollers 11 and an upper and lower pair of pulling rollers 12 that allow a film F taken from a raw-film roll 10 to be continuously fed in a single direction; a belt mechanism 7 that includes belts 72 wound on the lateral ends of the lower feeding roller 11 and the lower pulling roller 12 both disposed below the film F; and a holding mechanism 40 that alternately performs a process for holding the belts 72 and a process for releasing the belts 72. The feeding rollers 11 and the pulling rollers 12 are formed longer than the dimension of the film F defined in a direction substantially perpendicular to the film-feeding direction P (width direction).

Each of the lateral ends of the feeding rollers 11 and the pulling rollers 12 is provided with a gear.

The belts 72 are made of a material with flexibility such as rubber and have inner peripheries provided with engagement portions (not shown) capable of being engaged with the gears of the feeding rollers 11 and the pulling rollers 12. In this exemplary embodiment, the gears for driving the belts 72 are provided to at least a part of each of the feeding rollers 11 and the pulling rollers 12.

With the above arrangement, when the feeding rollers 11 and the pulling rollers 12 are rotated, the film F is fed and the belts 72 are rotated in synchronization with the film F.

The holding mechanism 40 includes a pair of holding rods 401 and 402 vertically opposed to each other with the belts 72 (objects to be held) interposed therebetween, and a rod advancing-and-retracting mechanism 43 that advances and retracts the holding rod 402 on the upper side. The holding mechanism 40 is synchronized with the film F. The holding rod 401 on the lower side is fixed on the upper surface of a base body 20 on the downstream side in the film-feeding direction P relative to a block 31. The holding rod 401 is provided by a square bar member with a rectangular cross section. The longitudinal direction of the holding rod 401 is set perpendicular to the film-feeding direction P and the length of the holding rod 401 is longer than a dimension of a space between the respective sides of the two belts 72.

The holding rod 402 on the upper side is provided by a square bar member with a rectangular cross section as in the holding rod 401. The longitudinal direction of the holding rod 402 is also set perpendicular to the film-feeding direction P. The length in the longitudinal direction of the holding rod 402 is substantially the same as that of the holding rod 401. The two belts 72 are held between the opposed flat surfaces of the holding rods 401 and 402 at both sides of the opposed flat surfaces. Thus, a predetermined gap is defined between the central portions of the opposed flat surfaces so that the film F is inserted therein.

Next, description will be made on the operation of the continuous machining device according to the second exemplary embodiment.

Initially, while the film F is fed from the raw-film roll 10 at a predetermined speed, the rotation of the feeding rollers 11 and the pulling rollers 12 is transmitted to the belts 72, so that the belts 72 are rotated in synchronization with the film F at the same speed as the film F.

Upon detection of one of the print marks FM on the film F, a sensor 6 sends a detection signal to the holding mechanism 40 via the controller so that the process for holding the belts 72 is performed by the holding mechanism 40. Since the film F and the belts 72 are constantly moved at the predetermined speed, the holding mechanism 40, a film machining mechanism 3 and a slider 2 are moved together with the film F and the belts 72. After elapse of a predetermined time, a punch driving mechanism 32 is operated to punch the holes A in the film F in the same manner as in the first exemplary embodiment.

Then, after elapse of the predetermined time, a signal is sent from the controller to the holding mechanism 40, so that the holding mechanism 40 performs the process for releasing the belts 72.

As a result, while the film F is still constantly fed at the predetermined speed, the holding mechanism 40, the film machining mechanism 3 and the slider 2 are simultaneously returned in the opposite direction to the film-feeding direction P to their respective original positions by the return mechanism 5.

Therefore, according to the second exemplary embodiment, the following advantages can be obtained in addition to the advantages (1) to (3) and (5) to (12) according to the first exemplary embodiment.

(13) Since the holding mechanism 40 alternately performs the process for holding the belts 72 rotated in synchronization with the film F and the process for releasing the belts 72, it is possible to move the holding mechanism 40 and the film machining mechanism 3 in synchronization with the film F without directly holding the film F. Thus, even when the film F has a low strength, the predetermined punching process can be applied to the film F.
(14) The belts 72 are wound on the feeding roller 11 and the pulling roller 12 to synchronize the holding mechanism 40 with the film F. Thus, the synchronization between the holding mechanism 40 and the film F can be reliably attained with a simple structure.
(15) Since the belts 72 are made of a material with flexibility such as rubber, the belts 72 can be held between the holding rods 401 and 402 without slippage. Thus, the synchronization between the holding mechanism 40 and the film F can be further ensured.

Incidentally, the scope of the present invention is not restricted to the embodiments described above, but includes modifications and improvements as long as an object of the present invention can be achieved.

For instance, while the belts 72 are wound on the feeding roller 11 and the pulling roller 12 to be moved in synchronization with the film F in the second exemplary embodiment, the invention is not limited thereto. For instance, any arrangement to turn a belt or a chain may be provided between the feeding rollers 11 and the raw-film roll 10.

Though the film machining mechanism 3 is provided by the punching mechanism in the above exemplary embodiments, the punching mechanism may be provided by a sealing mechanism in the present invention. Specifically, the film machining mechanism 3 may be provided by a sealing mechanism including a pair of sealing bars opposed to the film F, the sealing mechanism advancing and retracting one of the sealing bars relative to the other sealing bar. For instance, it is possible to employ an arrangement in which the sealing bars are connected to the pistons 36 of the air cylinders 35 via the joint 34 and a seal receiving table that is opposed to the sealing bars with the film F interposed therebetween is fixed to the base body 20.

When the film machining mechanism 3 is provided by the punching mechanism, the shape of the formed holes A is not be a circle but may be a triangle, a square, an oval, or the like. In other words, while description is made on the example where the holes A are formed to produce the standing pouch as an example of the packaging bag in the above exemplary embodiments, the shape, the number and the formation position of the holes A may be appropriately determined depending on usage in the present invention.

Furthermore, in the present invention, the upper-side holding rod 42 (402) of the pair of holding rods 41 and 42 (401 and 402) may be fixed and the lower-side holding rod 41 (401) may be advanced and retracted. Alternatively, both of the pair of holding rods 41 and 42 (401 and 402) may be moved close to and away from each other.

While the rod advancing-and-retracting mechanism 43 of the holding mechanism 4 (40) includes the air cylinders 44, the present invention is not limited thereto. For instance, a driving mechanism including a motor and a ball screw may be employed in place of the air cylinders 44. Specifically, it is possible to employ an arrangement where the lower end of the ball screw is connected to the upper-side holding rod 42 (402) and the motor is connected to the upper end of the ball screw.

In the present invention, the holding mechanisms 4 (40) may be disposed on both the downstream side and the upstream side in the film-feeding direction P so that the film machining mechanism 3 is interposed between the holding mechanisms 4 (40). Since the holding mechanisms 4 (40) are disposed on both the sides of the film machining mechanism 3, deformation of the film F can be reliably prevented during the operation of the film machining mechanism 3.

While the return mechanism 5 including the cylinder mechanism 51 connected to the distal end of the slider 2 in the film-feeding direction is provided in the above exemplary embodiments, the return mechanism 5 is not necessarily provided in the present invention. Even when the return mechanism 5 is provided, the arrangement thereof is not limited to the above one.

For instance, the cylinder mechanism may be replaced with a spring. By using the spring, the structure of the return mechanism 5 can be more simplified. However, as the deformation (shrinkage) of the spring is increased, the force applied to the film F held by the holding mechanism 4 is increased. As a result, a trouble such as elongation of the film F may be caused. By using the cylinder as in the above exemplary embodiment, uniform biasing force is constantly applied, thereby preventing such a trouble. While the slider 2 is employed as the support mechanism in the above exemplary embodiments, a driving mechanism including a motor and a ball screw may be employed in place of the slider 2 in the present invention.

1. A continuous machining device capable of continuously machining a film continuously fed in a single direction, the continuous machining device comprising:
a film machining mechanism that machines the film;
a holding mechanism that alternately performs a process for holding the film and a process for releasing the film;
a support mechanism that supports the film machining mechanism and the holding mechanism in a reciprocative manner relative to a feeding direction of the film; and
a return mechanism that returns the film machining mechanism and the holding mechanism to respective original positions thereof.

2. A continuous machining device capable of continuously machining a film continuously fed in a single direction, the continuous machining device comprising:
a film machining mechanism that machines the film;
a belt mechanism that includes a plurality of rollers each being longer than a widthwise dimension of the film and a belt wound on the rollers to be synchronized with the film;
a holding mechanism that alternately performs a process for holding the belt and a process for releasing the belt;
a support mechanism that supports the film machining mechanism and the holding mechanism in a reciprocative manner relative to a feeding direction of the film; and
a return mechanism that returns the film machining mechanism and the holding mechanism to respective original positions thereof.

3. The continuous machining device according to claim 1 or 2, further comprising a sensor that detects a predetermined position on the film, wherein
an operation of the holding mechanism is controlled by a signal from the sensor.

4. The continuous machining device according to any one of claims 1 to 3, wherein
the holding mechanism includes: a pair of rods opposed to each other with an object to be held being interposed therebetween; and a rod advancing-and-retracting mechanism that advances and retracts at least one of the rods.

5. The continuous machining device according to any one of claims 1 to 4, wherein
the support mechanism includes a slider on which the film machining mechanism and the holding mechanism are mounted.

6. The continuous machining device according to any one of claims 1 to 5, wherein
the return mechanism includes a cylinder mechanism that constantly biases the film machining mechanism and the holding mechanism in an opposite direction to the feeding direction of the film.

7. The continuous machining device according to any one of claims 1 to 6, wherein
the film machining mechanism is provided by a punching mechanism that forms a hole in the film.
